(19) United States
(12) Patent Application Publication
(10) Pub. No.: US 2004/0028981 A1
(43) Pub. Date: Feb. 12, 2004

(54) Fuel cell separator manufacturing method and fuel cell separator

(76) Inventors: Ayumi Horiuchi, Okazaki-shi (JP); Takenori Ikeda, Okazaki-shi (JP); Kazuo Saito, Okazaki-shi (JP)

Correspondence Address: BIRCH STEWART KOLASCH & BIRCH, PO BOX 747, FALLS CHURCH, VA, 22040-0747, US

(21) Appl. No.: 10/636,607

(22) Filed: Aug. 8, 2003

(30) Foreign Application Priority Data
Aug. 9, 2002 (JP) 2002-233627

(51) Int. Cl. H01M 8/02; B29C 43/02

(52) U.S. Cl. 429/34; 264/241; 264/319

(57) ABSTRACT

A fuel cell separator having dense areas and porous areas is manufactured by charging powdered molding material into a compression mold, then compression molding the powdered material. The powdered material is charged respectively for the dense areas of the separator and for the porous areas of the separator, following which the respectively charged molding materials are integrally compression molded to form dense areas and porous areas. This process can be used to inexpensively mass-produce fuel cell separators in which dense areas and porous areas are selectively formed where required. The respective areas can be conferred with a uniform density or porosity even in separators having flow channels of complex shape.

### BACKGROUND OF THE INVENTION

1. Technical Field

The present invention relates to a method of manufacturing fuel cell separators. The invention also relates to fuel cell separators obtained by this method.

2. Prior Art

Fuel cells are devices which, when supplied with a fuel such as hydrogen and with atmospheric oxygen, cause the fuel and oxygen to react electrochemically, producing water and directly generating electricity. Because fuel cells are capable of achieving a high fuel-to-energy conversion efficiency and are environmentally friendly, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly solid polymer fuel cells, are built in the form of modules composed of a stack of at least several tens of unit cells. Each unit cell has a pair of plate-like separators with a plurality of ribs on either side thereof that define channels for the flow of gases such as hydrogen and oxygen. Disposed between the pair of separators in the unit cell are a solid polymer electrolyte membrane and gas diffusing electrodes made of carbon paper.

The role of the fuel cell separators is to confer each unit cell with electrical conductivity, to provide flow channels for the supply of fuel and air (oxygen) to the unit cells, and to serve as a separating or boundary membrane between adjacent unit cells. Qualities required of the separators include high electrical conductivity, high gas impermeability, electrochemical stability and hydrophilic properties.

These fuel cell separators are produced in a variety of ways. One prior-art process involves cutting the flow channels from porous fired carbon. In another prior-art process, described in U.S. Pat. No. 6,187,466, a slurry composed of graphite powder, binder resin and cellulose fibers is formed into a sheet by a papermaking process, following which the sheet is graphitized.

In the first prior-art process mentioned above, the flow channels are formed by a cutting operation. In addition to being labor intensive, and thus more costly, this approach results in a lower yield. Moreover, cutting is poorly suited for the production of fuel cell separators having flow channels of complex shape. Also, when the separator is conferred with porosity by the use of molded carbon, it often lacks adequate strength and tends to incur damage during handling or stack assembly.

The latter prior-art process requires a graphitizing step. This increases the complexity of the production operation and raises production costs, and thus is not economical.

### SUMMARY OF THE INVENTION

It is therefore one object of the invention to provide a method capable of inexpensively mass-producing fuel cell separators in which dense areas and porous areas can be selectively formed where required and these respective areas can be conferred with a uniform density or porosity even in separators having flow channels of complex shape. Another object of the invention is to provide fuel cell separators obtained by this method.

We have discovered that when a compression mold for a fuel cell separator is charged with powdered molding material in such a way that the powdered material is charged respectively for dense areas of the separator and for porous areas of the separator, and the respectively charged powdered materials are then integrally compression molded, dense areas and porous areas can easily be formed where required on the separator. Moreover, uniform density or porosity at each dense area or porous area can easily be achieved even in separators having flow channels of complex shape.

Accordingly, the invention provides a method of manufacturing a fuel cell separator having dense areas and porous areas, which method comprises the steps of charging powdered molding material into a compression mold, then compression molding the powdered material. The powdered material is charged respectively for the dense areas of the separator and for the porous areas of the separator, following which the respectively charged powdered materials are integrally compression molded to form dense areas and porous areas.

In one preferred embodiment, the powdered material charged for the dense areas of the separator and the powdered material charged for the porous areas of the separator are the same material, but the amount of powdered material charged for the dense areas differs from the amount of powdered material charged for the porous areas.

In another preferred embodiment, the powdered material charged for the dense areas of the separator and the powdered material charged for the porous areas of the separator have different flow properties and/or cure rates.

In yet another preferred embodiment, the powdered material charged for the dense areas of the separator and the powdered material charged for the porous areas of the mold are different materials.

The invention also provides a fuel cell separator obtained by the foregoing method of manufacturing fuel cell separators.

### BRIEF DESCRIPTION OF THE DRAWINGS

FIG. 1 illustrates a powdered material charging device such as may be used in one embodiment of the invention. FIG. 1a is a perspective view of the device, and FIG. 1b is a sectional view taken along line b-b in FIG. 1a.

FIG. 2 shows schematic sectional views of individual steps, from charging of the powdered material to compression molding, in the same embodiment of the invention.

FIG. 3 is a top view showing the charging member of a charging device such as may be used in another embodiment of the invention.

### DETAILED DESCRIPTION OF THE INVENTION

The objects, features and advantages of the invention will become more apparent from the following detailed description, taken in conjunction with the foregoing diagrams.

As noted above, the inventive method of manufacturing fuel cell separators involves charging powdered molding material into a compression mold, then compression molding the powdered material to form a fuel cell separator having dense areas and porous areas. The powdered material is charged respectively for the dense areas of the separator and for the porous areas of the separator, following which the respectively charged powdered materials are integrally compression molded to form dense areas and porous areas.

The powdered molding material used in the method of the invention may be any material commonly employed in the production of fuel cell separators, including materials prepared by subjecting a mixture of electrically conductive powder and resin to a compounding operation.

The electrically conductive powder is not subject to any particular limitation. Illustrative examples include natural graphite, synthetic graphite and expanded graphite. The conductive powder has an average particle size in a range of preferably about 10 to 100 μm, and most preferably 20 to 60 μm.

The resin may be suitably selected from among thermoset resins, thermoplastic resins and other resins commonly used in fuel cell separators. Specific examples of resins that may be used include phenolic resins, epoxy resins, acrylic resins, melamine resins, polyamide resins, polyamideimide resins, polyetherimide resins and phenoxy resins. If necessary, these resins may be heat treated.

No limitation is imposed on the proportions in which these respective components are blended, although it is desirable for the powdered molding material to include, per 100 parts thereof: 50 to 99 parts by weight, and especially 65 to 90 parts by weight, of the conductive powder; and 1 to 50 parts by weight, and especially 5 to 20 parts by weight, of the resin.

In the practice of the invention, these blended components are typically used after being subjected to a compounding operation carried out by any suitable method. Blended components that have been stirred, granulated and dried by known methods may be used, although it is preferable to use as the powdered molding material a blend which has been screened to prevent secondary agglomeration and adjusted to a specific particle size. The powdered molding material has an average particle size which varies with the particle size of the conductive powder used, but is preferably at least 60 μm. The particle size distribution is preferably from 10 μm to 2.0 mm, more preferably from 30 μm to 1.5 mm, and most preferably from 50 μm to 1.0 mm.

If necessary, the powdered molding material may include also an inorganic filler such as carbon fibers, other carbonaceous materials or activated alumina in an amount of 0.1 to 20 parts by weight, and especially 1 to 10 parts by weight, per 100 parts by weight of the overall powdered molding material.

The pressure applied during compression molding is not subject to any particular limitation, and may be set as appropriate for the denseness required in the separator. The molding pressure is generally from 0.98 to 14.7 MPa, and preferably from 1.96 to 9.8 MPa. At a pressure less than 0.98 MPa, a strength sufficient to maintain the shape of the fuel cell separator may not be achieved. On the other hand, at a pressure greater than 14.7 MPa, strain may arise in the molding machine and mold, possibly lowering the planar and dimensional precision of the resulting fuel cell separator. In addition, pores may become filled, increasing the possibility that porous areas will not form in the separator.

In the method of the invention, dense areas and porous areas are formed in the fuel cell separator by respectively charging powdered molding material for the dense areas of the separator and for the porous areas of the separator. In one preferred embodiment, the same powdered molding material is charged for both the dense areas and the porous areas of the separator, but different amounts of the powdered material are charged to form the dense areas versus the porous areas. The density following compression molding thus differs at the respective places, giving a separator having dense areas and porous areas.

For example, by charging a larger amount of the powdered material at places on the fuel cell separator that must be particularly strong than at other places and compression molding, the places requiring strength can be made dense areas and the other places can be made porous areas.

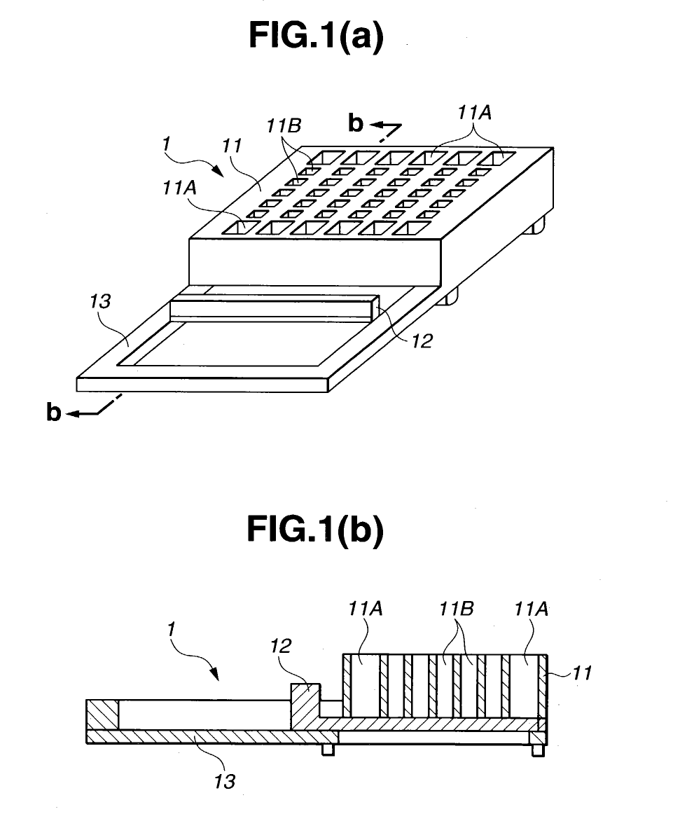

Any suitable method may be used to charge the powdered material into the compression mold. For instance, use can be made of a charging device 1 like that shown in FIG. 1.

Referring to FIG. 1, the powdered material charging device 1 has a charging member 11, a slide plate 12 situated below the charging member 11, and a base 13 which is integrally molded with the charging member 11 and forms a frame that encloses the slide plate 12.

The charging member 11 has formed therein first charging openings 11A and second charging openings 11B which are each of substantially rectangular shape. In the illustrated example, the first charging openings 11A are arranged in two rows positioned at the upper and lower edges of the charging member 11 in FIG. 1 and the second charging openings 11B are arranged elsewhere on the charging member 11.

The respective charging openings 11A and 11B pass vertically through the charging member 11 and are each open at the bottom thereof.

The first charging openings 11A are formed so as to have a larger bore than the second charging openings 11B, the difference in the bores being used to vary the amount of powdered material charged into the compression mold. That is, the relative sizes of the bores of charging openings 11A and 11B are set so that larger amounts of the powdered material are charged at both edges of the charging member 11 which correspond to the dense areas of the fuel cell separator to be obtained, and smaller amounts of the powdered material are charged at the center of the charging member 11 which corresponds to the porous areas of the separator. The respective bores of charging openings 11A and 11B, and the arrangement of these openings 11A and 11B, can be selected as appropriate for the particular type of separator to be manufactured.

As noted above, the base 13 is integrally molded with the charging member 11. However, as shown in FIG. 1b, the portion of the base 13 over which the respective charging openings 11A and 11B are present is hollow.

A gap of a given size is formed between this base 13 and the charging member 11. The slide plate 12 is disposed so as to be freely slideable within this gap.

The slide plate 12 is designed so as to be freely movable from a condition in which the bottoms of the respective charging openings 11A and 11B are closed to a condition in which they are open.

Charging of the powdered molding material into the compression mold using the charging device 1 constructed as described above and compression molding may be carried out as follows.

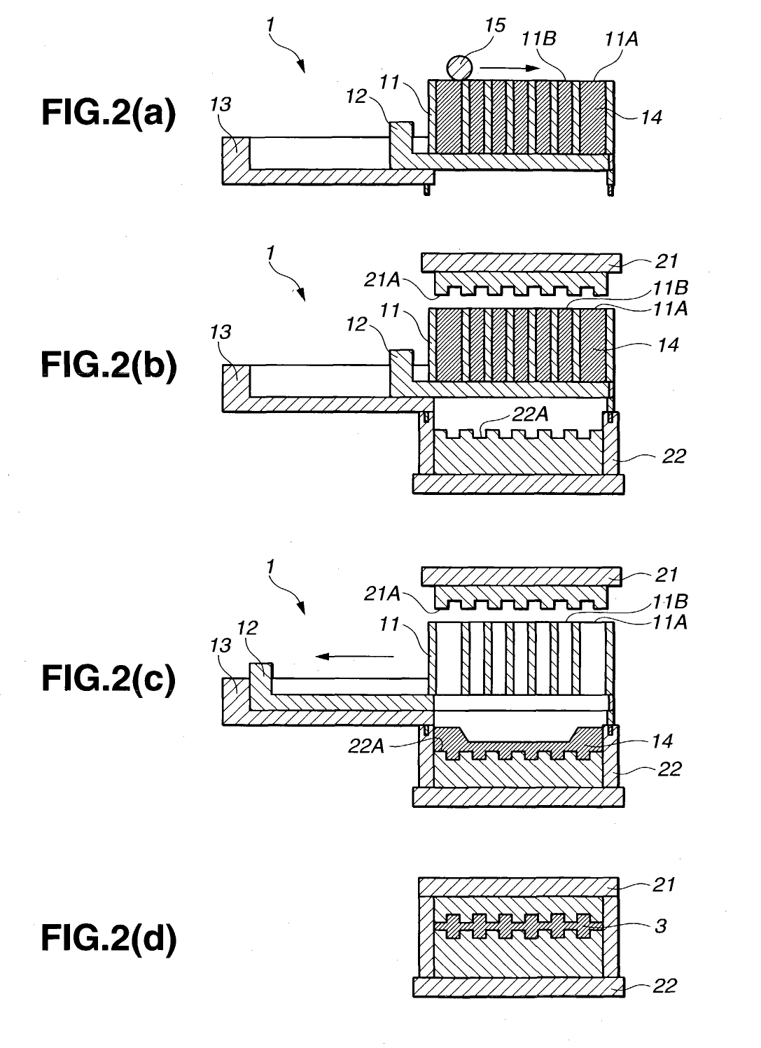

As shown in FIG. 2a, a powdered molding material 14 is charged into each of the charging openings 11A and 11B in the charging member 11, then is leveled off with a leveling rod 15, thereby filling each of the openings 11A and 11B with predetermined amounts of the molding material.

Next, as shown in FIG. 2b, the charging device 1 filled with the powdered molding material 14 is set on the bottom half 22 of a compression mold in a press having a top mold half 21 and bottom mold half 22. The bottom half 22 bears a pattern 22A for forming the gas flow channels on one side of the fuel cell separator, and the top half 21 bears a pattern 21A for forming the gas flow channels on the other side of the fuel cell separator.

Alternatively, a preform molded into a shape that substantially conforms with the shape of the pattern 22A on the bottom half 22 of the mold can instead be placed on the bottom half 22.

After the charging device 1 has been set on the bottom half 22, as shown in FIG. 2c, the slide plate 12 slides toward the left side in the diagram so as to open the bottoms of the respective charging openings 11A and 11B, allowing the powdered molding material 14 filled into these openings to fall onto the bottom half 22 of the mold.

As a result, the amount of the powdered molding material 14 charged at the left and right edges in FIG. 2 is large, and the amount of molding material 14 charged in other areas is small.

As shown in FIG. 2d, by clamping the mold shut in this state with the top half 21 thereof and compression molding at a molding temperature of, say, 100 to 250° C., and preferably 140 to 200° C., and a molding pressure of 0.98 to 14.7 MPa, there can be obtained a fuel cell separator 3 having dense areas at the left and right edges in FIG. 2 and porous areas elsewhere.

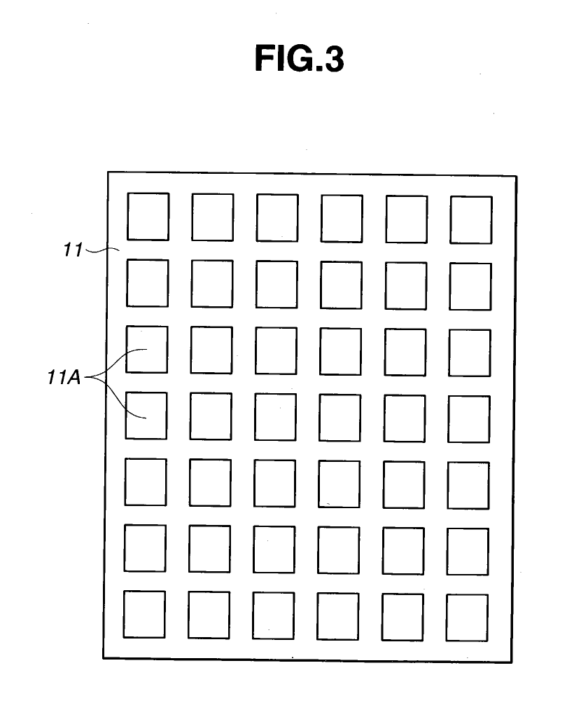

Use can also be made of a method of forming dense areas and porous areas by means of a process that employs a charging member 11 like that shown in FIG. 3 which has charging openings 11A that are all of the same size and charges the powdered material a plurality of times wherever dense areas are to be formed.

In another embodiment of the invention, dense areas and porous areas can be formed in the fuel cell separator by conferring the powdered material charged in the dense areas and the powdered material charged in the porous areas with different flow properties and/or cure rates. In such cases, the powdered material for porous areas and the powdered material for dense areas are each compounded separately.

The method of conferring the above powdered materials with different flow properties and/or cure rates may consist of, for example, using the same type of resin in the powdered materials for dense and porous areas of the separator but varying its flow properties and/or cure rate. Specifically, if the resin used is an epoxy resin or a phenolic resin, the flow properties and/or cure rate can be varied by using different amounts of curing accelerator in the resin for dense areas and in the resin for porous areas, respectively.

The amount of accelerator used in dense areas is typically 0.01 to 5 wt %, and preferably 0.01 to 5 wt %, based on the overall powdered material. The amount of accelerator used in porous areas is typically 1 to 20 wt %, and preferably 5 to 10 wt %, based on the overall powdered material.

If the resin in the powdered material is a resole-type phenolic resin, a method may be employed in which the phenolic resin is preheated at 20 to 120° C., and preferably 50 to 90° C., to increase its molecular weight for use as the resin in porous areas of the separator.

In yet another embodiment of the invention, dense areas and porous areas can be formed in the fuel cell separator by using one type of powdered material for dense areas and another type of powdered material for porous areas to regulate the flow properties during compression molding and thus control the densities at the respective areas of the molded separator.

A number of specific techniques may be employed for this purpose. One such technique involves the use of flake graphite as the conductive powder in the powdered material for dense areas and the use of another type of graphite such as synthetic graphite as the conductive powder in the powdered material for porous areas. In another technique, carbon having a relatively large specific surface area is included in the powdered material for the porous areas in an amount of 0.1 to 30 parts by weight, and preferably 1 to 10 parts by weight, per 100 parts by weight of the overall powdered material. In yet another technique, an organic or inorganic fibrous component, or whiskers, is included in the powdered material for porous areas in an amount of 0.1 to 20 parts by weight, and preferably 1 to 10 parts by weight, per 100 parts by weight of the overall powdered material. In still another technique, the amount of resin in the powdered material for dense areas is made 1 to 20 parts by weight, and preferably 3 to 10 parts by weight, higher than in the powdered material for porous areas.

In these techniques for varying the flow properties and/or cure rate of the powdered material and techniques involving the use of different powdered materials in dense areas versus porous areas, no particular limitation is imposed on the method of charging the powdered molding material into the compression mold. For example, a method in which the powdered material for dense areas and the powdered material for porous areas are interdispersed and charged together into the compression mold, a method in which the powdered material for dense areas and the powdered material for porous areas are charged into the compression mold in a multilayer arrangement, or a combination thereof, may be suitably selected and used.

Any suitable device may be used to charge the powdered molding material. The charging device 1 described above and shown in FIG. 1 may be used in the foregoing cases. For example, when the charging device 1 has a charging member 11 like that shown in FIG. 3 with charging holes 11A which are all of the same size and of substantially rectangular shape, the powdered molding material can be charged into the compression mold by a method similar to that described above.

In this case, a powdered material for dense areas can be filled into those charging openings 11A located at positions corresponding to the dense areas of the separator and a powdered material for porous areas can be filled into those charging openings 11A located at positions corresponding to the porous areas of the separator. Alternatively, a material obtained by mixing respective powdered materials for the dense areas and for the porous areas can be filled into all the charging openings 11A.

In cases where the respective powdered materials for dense areas and for porous areas are charged in a multilayer arrangement, this may be done by using the above-described charging device to carry out charging repeatedly; i.e., two or more times. In this case, the order in which the respective powdered materials for dense areas and porous areas, or mixtures of both, are charged is not subject to any particular limitation and may be selected as appropriate for the desired fuel cell separator.

It is advantageous for the porous areas of the fuel cell separator described above to have a pore diameter of 0.01 to 50 μm, and preferably 0.1 to 10 μm; and a porosity of 1 to 50%, preferably 5 to 50%, and most preferably 10 to 30%.

At a pore diameter smaller than 0.01 μm, water produced during power generation by the fuel cell passes through the separator with greater difficulty and may obstruct the gas flow channels. On the other hand, at a pore diameter larger than 50 μm, precise formation of the channel shapes may not be possible.

At a porosity of less than 1%, the ability to absorb water that forms during power generation decreases, which may result in obstruction of the gas flow channels. On the other hand, at a porosity of more than 50%, precise formation of the channel shapes may be impossible.

Fuel cell separators obtained by the production method of the invention are highly suitable for use as separators in solid polymer fuel cells. If necessary, these fuel cell separators can also be administered hydrophilizing treatment or hydrophobizing treatment.

As described above, the present invention enables fuel cell separators endowed with the required porosity in the required places—that is, having both dense areas and porous areas—to be inexpensively mass-produced by a simple and expedient method. Moreover, because the method of the invention is capable of molding flow channel-bearing plates, it eliminates the need for machining operations and requires no firing step, thus making it possible to lower production costs.

In addition, the inventive method integrally unites the dense areas and porous areas of the separator, thus minimizing cracking or breaking due to interfacial strain and coefficient of expansion differences between the dense areas and porous areas when the separator is subjected to heat and pressure.

### EXAMPLES

The following examples and comparative examples are provided to illustrate the invention, and are not intended to limit the scope thereof. Average particle sizes given below were measured using a Microtrak particle size analyzer.

### Example 1

A composition of 86 parts by weight of artificial graphite powder having an average particle size of 20 μm and 14 parts by weight of phenolic resin was granulated and dried, then screened, yielding a powdered molding material having a particle size adjusted to 0.5 to 1.0 mm.

This powdered molding material was charged into the respective charging openings 11A and 11B of the charging device 1 shown in FIGS. 1 and 2, and leveled off at the top of the openings with a leveling rod 15. Next, the slide plate 12 was slid so as to open the bottom of the respective charging openings 11A and 11B, thereby charging the powdered molding material 14 onto the bottom half 22 of a compression mold.

In this example, the first charging openings 11A had a cross-sectional size of 21×21 mm, the second charging openings 11B had a cross-sectional size of 15×15 mm, and each first charging opening 11A had a volume twice as large as the volume of each second charging opening 11B. A charging member 11 having 20 first charging openings 11A and 16 second charging openings 11B was used.

Next, the top half 21 of the mold was clamped shut over the bottom half 22 and compression molding was carried out at a pressure of 4.9 MPa to form a fuel cell separator.

### Example 2

Aside from using 90 parts by weight of an artificial graphite powder having an average particle size of 60 μm and 10 parts by weight of phenolic resin, a fuel cell separator was obtained in the same way as in Example 1.

### Example 3

Aside from using 80 parts by weight of an artificial graphite powder having an average particle size of 60 μm, 10 parts by weight of phenolic resin and 10 parts by weight of carbon fibers, a fuel cell separator was obtained in the same way as in Example 1.

### Comparative Example 1

Aside from uniformly charging the powdered molding material onto the bottom half 22 of the compression mold, a fuel cell separator was obtained in the same way as in Example 1.

### Example 4

A powdered molding material for dense areas having a particle size of 0.5 mm or less was prepared by mixing 83 parts by weight of artificial graphite powder having an average particle size of 20 μm and 17 parts by weight of resole-type phenolic resin to form a composition, granulating and drying the composition, then screening the dried composition.

A powdered molding material for porous areas having a particle size of 0.5 mm or less was prepared by granulation and drying, followed by screening, as in the case of the powdered material for dense areas described above, except that the resole-type phenolic resin was heated at 80° C. for 2 hours prior to use.

Using charging member 11 shown in FIG. 3 instead of charging member 11 of charging device 1 shown in FIG. 1, powdered material for dense areas and powdered material for porous areas were filled separately into respective portions of the charging member 11 as in Example 1. Compression molding was then carried out under the same conditions as in Example 1, forming a fuel cell separator.

### Example 5

A powdered molding material for dense areas having a particle size of 0.5 mm or less was prepared by blending 83 parts by weight of artificial graphite powder having an average particle size of 60 μm, 17 parts by weight of epoxy resin, and 0.001 wt % of a curing accelerator, based on the combined amount of graphite powder and epoxy resin, to form a composition, granulating and drying the composition, then screening the dried composition.

Aside from changing the amount of curing accelerator to 1 wt %, a powdered molding material for porous areas having a particle size of 0.5 mm or less was prepared in the same way as the foregoing powdered material for dense areas by granulation and drying, followed by screening.

Using charging member 11 shown in FIG. 3 instead of charging member 11 of charging device 1 shown in FIG. 1, powdered material for dense areas and powdered material for porous areas were filled separately into respective portions of the charging member 11 as in Example 1. Compression molding was then carried out under the same conditions as in Example 1, forming a fuel cell separator.

### Example 6

A powdered molding material for dense areas having a particle size of 0.5 mm or less was prepared by mixing 83 parts by weight of natural graphite powder having an average particle size of 30 μm and 17 parts by weight of phenolic resin to form a composition, granulating and drying the composition, then screening the dried composition.

A powdered molding material for porous areas having a particle size of 0.5 to 1.0 mm was prepared by mixing 86 parts by weight of artificial graphite powder having an average particle size of 20 μm and 14 parts by weight of phenolic resin to form a composition, granulating and drying the composition, then screening the dried composition.

Using charging member 11 shown in FIG. 3 instead of charging member 11 of charging device 1 shown in FIG. 1, powdered material for dense areas and powdered material for porous areas were filled separately into respective portions of the charging member 11 as in Example 1. Compression molding was then carried out under the same conditions as in Example 1, forming a fuel cell separator.

### Example 7

A powdered molding material for dense areas having a particle size of 0.5 mm or less was prepared by mixing 75 parts by weight of artificial graphite powder having an average particle size of 60 μm and 25 parts by weight of phenolic resin to form a composition, granulating and drying the composition, then screening the dried composition.

A powdered molding material for porous areas having a particle size of 0.5 or less was prepared by mixing 90 parts by weight of artificial graphite powder having an average particle size of 60 μm and 10 parts by weight of phenolic resin to form a composition, granulating and drying the composition, then screening the dried composition.

Using charging member 11 shown in FIG. 3 instead of charging member 11 of charging device 1 shown in FIG. 1, powdered material for dense areas and powdered material for porous areas were filled separately into respective portions of the charging member 11 as in Example 1. Compression molding was then carried out under the same conditions as in Example 1, forming a fuel cell separator.

### Example 8

A powdered molding material for dense areas was prepared in the same way as in Example 7.

A powdered molding material for porous areas having a particle size of 0.5 or less was prepared by mixing 80 parts by weight of artificial graphite powder having an average particle size of 60 μm, 10 parts by weight of phenolic resin and 10 parts by weight of activated carbon to form a composition, granulating and drying the composition, then screening the dried composition.

Using charging member 11 shown in FIG. 3 instead of charging member 11 of charging device 1 shown in FIG. 1, powdered material for dense areas and powdered material for porous areas were filled separately into respective portions of the charging member 11 as in Example 1. Compression molding was then carried out under the same conditions as in Example 1, forming a fuel cell separator.

### Example 9

A powdered molding material for dense areas was prepared in the same way as in Example 7.

A powdered molding material for porous areas having a particle size of 0.5 or less was prepared by mixing 80 parts by weight of artificial graphite powder having an average particle size of 60 μm, 10 parts by weight of phenolic resin and 10 parts by weight of carbon fibers to form a composition, granulating and drying the composition, then screening the dried composition.

Using charging member 11 shown in FIG. 3 instead of charging member 11 of charging device 1 shown in FIG. 1, powdered material for dense areas and powdered material for porous areas were filled separately into respective portions of the charging member 11 as in Example 1. Compression molding was then carried out under the same conditions as in Example 1, forming a fuel cell separator.

The dense areas and porous areas of the fuel cell separators produced in each of the above examples and comparative examples were subjected to measurements of bulk density, porosity, flexural strength, flexural modulus and specific resistance, and were also subjected to cooling-heating cycle tests. The methods used for measurement and evaluation are described below. The results are presented in Table 1.

(1) Porosity

Measured by mercury injection porosimetry.

(2) Cooling-Heating Cycle Test

The fuel cell separator was subjected to 150 cooling-heating cycles, each consisting of 30 minutes at 90° C. and 30 minutes at −40° C., following which boundaries between porous areas and dense areas of the separator were examined. The absence of any observable separation was indicated in the table as “no”; the presence of separation was indicated as “yes.”

(3) Flexural Strength, Flexural Modulus

Measured in general accordance with the method described in ASTM D790.

(4) Specific Resistance

Measured by the four-probe method described in JIS H-0602.

TABLE 1

| Bulk | | | | | Flexural | | Flexural | | Specific | |
|---|---|---|---|---|---|---|---|---|---|---|
| density | | Porosity | | Cooling- | strength | | modulus | | resistance | |
| (g/cm³) | | (%) | | heating | (MPa) | | (GPa) | | (mΩ · cm) | |
| Porous | Dense | Porous | Dense | cycle | Porous | Dense | Porous | Dense | Porous | Dense |
| areas | areas | areas | areas | test | areas | areas | areas | areas | areas | areas |

| | | | | | | | | | | | |
|---|---|---|---|---|---|---|---|---|---|---|---|
| Example 1 | 1.3 | 1.8 | 20 | 0 | no | 23 | 50 | 5.9 | 12 | 16 | 12 |
| Example 2 | 1.3 | 1.7 | 22 | 0 | no | 25 | 45 | 13 | 14 | 8 | 6 |
| Example 3 | 1.4 | 1.9 | 15 | 0 | no | 31 | 51 | 17 | 18 | 14 | 10 |
| Example 4 | 1.3 | 1.9 | 18 | 0 | no | 20 | 51 | 17 | 13 | 14 | 8 |
| Example 5 | 1.4 | 1.8 | 19 | 0 | no | 22 | 60 | 10 | 12 | 10 | 8 |
| Example 6 | 1.4 | 1.9 | 20 | 0 | no | 23 | 51 | 5.9 | 13 | 16 | 8 |
| Example 7 | 1.3 | 1.9 | 18 | 0 | no | 25 | 55 | 13 | 11 | 8 | 14 |
| Example 8 | 1.3 | 1.9 | 25 | 0 | no | 19 | 55 | 6 | 11 | 17 | 14 |
| Example 9 | 1.4 | 1.9 | 20 | 0 | no | 31 | 55 | 17 | 11 | 14 | 14 |
| Comparative | 1.4 | 1.4 | 20 | 20 | no | 23 | 23 | 5.9 | 5.9 | 16 | 16 |
| Example 1 | | | | | | | | | | | |

As is apparent from the results shown in Table 1, the fuel cell separators obtained in each of the above examples according to the invention had both porous areas and dense areas. Moreover, none of these fuel cell separators exhibited any separation between porous and dense areas in the cooling-heating cycle test. Hence, these fuel cell separators according to the invention all exhibited excellent bonding between areas of differing density and excellent durability.

In the fuel cell separator manufacturing method of the invention, a powdered molding material is charged into a compression mold in such a way that the powdered material is charged respectively for dense areas of the separator and for porous areas of the separator, following which the respectively charged powdered materials are integrally compression molded to form dense areas and porous areas. This method enables the inexpensive mass production of fuel cell separators having the required porosity in the required places; that is, having selectively formed dense areas and porous areas. Because the inventive method is also capable of molding flow channel-bearing plates, it reduces the need for labor-intensive machining operations and does not require a firing step, thus making it possible to lower production costs. Finally, because dense areas and porous areas of the separator are integrally formed, the separator does not readily crack or break from interfacial strain and coefficient of expansion differences between the dense areas and porous areas when subjected to heat and pressure.

Japanese Patent Application No. 2002-233627 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of manufacturing a fuel cell separator having dense areas and porous areas, comprising the steps of charging powdered molding material into a compression mold, then compression molding the powdered material;
wherein said powdered material is charged respectively for the dense areas of the separator and for the porous areas of the separator, following which the respectively charged powdered materials are integrally compression molded to form dense areas and porous areas.

2. The method of claim 1, wherein the powdered material charged for the dense areas of the separator and the powdered material charged for the porous areas of the separator are the same material, but the amount of powdered material charged for the dense areas differs from the amount of powdered material charged for the porous areas.

3. The method of claim 1, wherein the powdered material charged for the dense areas of the separator and the powdered material charged for the porous areas of the separator have different flow properties and/or cure rates.

4. The method of claim 1, wherein the powdered material charged for the dense areas of the separator and the powdered material charged for the porous areas of the separator are different materials.

5. A fuel cell separator obtained by the fuel cell separator manufacturing method of claim 1.
